(19) United States
(12) Patent Application Publication
(10) Pub. No.: US 2009/0067379 A1
(43) Pub. Date: Mar. 12, 2009

(54) SYSTEM AND METHOD FOR ALLOCATING RESOURCES IN A COMMUNICATION SYSTEM

(75) Inventors: Hyun-Kyung KIM, Suwon-si (KR); Min-Hee CHO, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/205,111

(22) Filed: Sep. 5, 2008

(30) Foreign Application Priority Data
Sep. 6, 2007 (KR) 2007-0090495

(51) Int. Cl. H04Q 7/20; H04Q 7/00

(52) U.S. Cl. 370/329; 455/509; 455/452.1

(57) ABSTRACT

A method and system for allocating feedback resources in a communication system are provided, in which a Base Station (BS) allocates a first feedback resource area for ACKnowledgment/Negative ACKnowledgment (ACK/NACK) messages for general packets and a second feedback resource area for ACK/NACK messages for fixed packets, transmits the general packets and the fixed packets to at least one Mobile Station (MS), receives ACK/NACK messages in the first and second feedback resource areas, and when at least one of the fixed packets is canceled from transmission after the transmission of the general packets and the fixed packets, transmits a bitmap message to the at least one MS indicating use or non-use of the second feedback resource area for each packet, to enable a feedback resource area allocated for the canceled fixed packet to be allocated to an ACK/NACK message for an additionally generated general packet.

### PRIORITY

This application claims the benefit under 35 U.S.C. §119(a) of a Korean patent application filed in the Korean Intellectual Property Office on Sep. 6, 2007 and assigned Serial No. 2007-90495, the entire disclosure of which is hereby incorporated by reference.

### BACKGROUND OF THE INVENTION

1. Field of the Invention

The present invention relates to a communication system. More particularly, the present invention relates to a system and method for allocating resources in a communication system.

2. Description of the Related Art

In a wireless communication system, a transmitter (e.g. a Base Station (BS)) transmits a resource allocation message to a receiver (e.g. a Mobile Station (MS)) to communicate with the receiver.

When the wireless communication system provides a service that generates packets periodically, for example, Voice over Internet Protocol (VoIP) data during frame #0 to frame #4, the BS transmits a fixed resource allocation message indicating the fixed position and size of a transmission packet to the MS by frame #0. During frame #1 to frame #4, the BS transmits packets to the MS according to the fixed resource allocation message transmitted in frame #0 without transmitting the fixed resource allocation message again. The BS can transmit a frame including a general packet and a fixed packet to the MS in the communication system. The term “general packet” refers to a packet for which resources vary in position and size in every frame. The BS transmits a resource allocation message indicating resource allocation information about the general packet to the MS in every frame and the BS transmits the general packet according to the resource allocation message that changes for every frame. The term “fixed packet” refers to a packet for which resources are fixed in position and size within a frame. The BS transmits a fixed resource allocation message including resource allocation information about the fixed packet to the MS at every preset interval. Alternatively, the BS transmits a fixed resource allocation message to the MS only for the first time before transmitting fixed packets and the BS transmits the fixed packets according to the fixed resource allocation message.

To increase the reliability and throughput of general packets and fixed packets, the communication system adopts a Hybrid Automatic Repeat reQuest (HARQ) scheme.

In the HARQ scheme, the MS checks for errors in a general packet or a fixed packet received from the BS and feeds back the results of the error check to the BS. If the result of the error check is that there is no error, the MS transmits to the BS an ACKnowledgment (ACK) message indicating successful packet reception. If the result of the error check is that there is an error, the MS transmits to the BS a Negative ACKnowledgment (NACK) message indicating failed packet reception.

For the BS to transmit a general packet or a fixed packet to the MS, there is a need for a method for allocating resources to the general or fixed packet. In addition, when HARQ applies to the general or fixed packet, there exists a need for a method for allocating resources so that the MS can feed back an ACK/NACK message for a received packet.

### SUMMARY OF THE INVENTION

An aspect of the present invention is to address at least the above-mentioned problems and/or disadvantages and to provide at least the advantages described below. Accordingly, an aspect of the present invention is to provide a system and method for allocating resources to a general packet and a fixed packet in a communication system.

Another aspect of the present invention is to provide a system and method for allocating resources to feed back an ACK/NACK message for a general packet and a fixed packet in a communication system using HARQ.

In accordance with an aspect of the present invention, a method for allocating feedback resources for a BS in a communication system is provided. In the method, a first feedback resource area is allocated for ACK/NACK messages for general packets and a second feedback resource area is allocated for ACK/NACK messages for fixed packets, the general packets and the fixed packets are transmitted to at least one MS, ACK/NACK messages are received in the first and second feedback resource areas, and when at least one of the fixed packets is canceled from transmission after the transmission of the general packets and the fixed packets, a bitmap message indicating use or non-use of the second feedback resource area for each packet is transmitted to the at least one MS, to enable a feedback resource area allocated for the canceled fixed packet to be allocated to an ACK/NACK message for an additionally generated general packet.

In accordance with another aspect of the present invention, a method for allocating feedback resources for a MS in a communication system. In the method, a first feedback resource area allocated for ACK/NACK messages for general packets and a second feedback resource area allocated for ACK/NACK messages for fixed packets are acquired, the general packets and the fixed packets are received from a BS, the ACK/NACK messages are transmitted to the BS in the first and second feedback resource areas, and when at least one of the fixed packets is canceled from transmission after transmission of the general packets and the fixed packets from the BS, a bitmap message indicating use or non-use of the second feedback resource area for each packet is received from the BS, to enable a feedback resource area allocated for the canceled fixed packet to be allocated to an ACK/NACK message for an additionally generated general packet.

In accordance with a further aspect of the present invention, a system for allocating feedback resources in a communication system is provided. In the system, at least one MS exists, and a BS allocates a first feedback resource area for ACK/NACK messages for general packets and a second feedback resource area for ACK/NACK messages for fixed packets, transmits the general packets and the fixed packets to the at least one MS, receives ACK/NACK messages in the first and second feedback resource areas, and when at least one of the fixed packets is canceled from transmission after the transmission of the general packets and the fixed packets, transmits a bitmap message indicating use or non-use of the second feedback resource area for each packet to the at least one MS, to enable a feedback resource area allocated for the canceled fixed packet to be allocated to an ACK/NACK message for an additionally generated general packet.

In accordance with still another aspect of exemplary embodiments of the present invention, a system for allocating feedback resources in a communication system is provided. In the system, a BS exists, and an MS acquires a first feedback resource area allocated for ACK/NACK messages for general packets and a second feedback resource area allocated for ACK/NACK messages for fixed packets, receives the general packets and the fixed packets from the BS, transmits the ACK/NACK messages in the first and second feedback resource areas to the BS, and receives from the BS, when at least one of the fixed packets is canceled from transmission after transmission of the general packets and the fixed packets from the BS, a bitmap message indicating use or non-use of the second feedback resource area for each packet, to enable a feedback resource area allocated for the canceled fixed packet to be allocated to an ACK/NACK message for an additionally generated general packet.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates a resource allocation method in a communication system according to an exemplary embodiment of the present invention;

FIG. 2 illustrates an operation for transmitting fixed packets in the communication system according to an exemplary embodiment of the present invention;

FIG. 3 illustrates an ACK/NACK CHannel (ACKCH) allocation method in an HARQ communication system according to an exemplary embodiment of the present invention;

FIG. 4 illustrates an ACKCH allocation method in the HARQ communication system according to an exemplary embodiment of the present invention;

FIG. 5 illustrates an ACKCH allocation method in the HARQ communication system according to an exemplary embodiment of the present invention;

FIG. 6 is a flowchart illustrating an operation of a BS in the communication system according to an exemplary embodiment of the present invention; and

FIG. 7 is a flowchart illustrating an operation of an MS for acquiring an ACKCH region in the communication system according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide a system and method for allocating resources to a general packet and a fixed packet in a communication system.

Exemplary embodiments of the present invention also provide a system and method for allocating resources in which ACK/NACK messages will be fed back for a general packet and a fixed packet in an HARQ communication system.

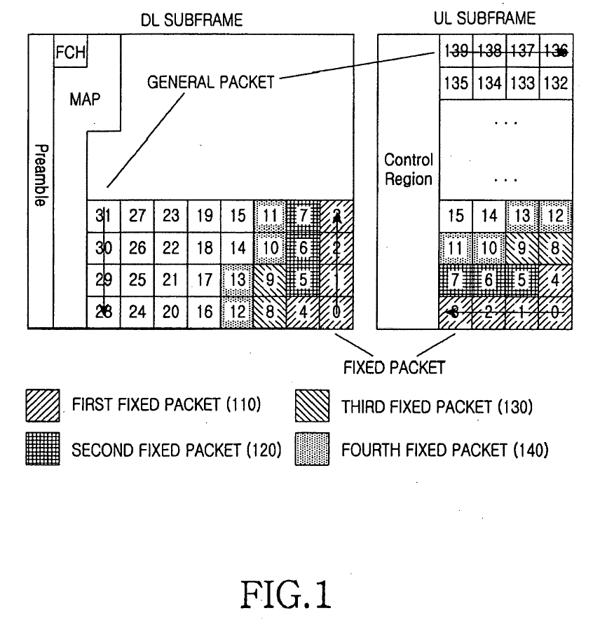

With reference to FIG. 1, a method for allocating resources to a fixed packet and a general packet in a communication system according to an exemplary embodiment of the present invention will be described below.

FIG. 1 illustrates a resource allocation method in a communication system according to an exemplary embodiment of the present invention.

Referring to FIG. 1, fixed packets are allocated to slot #0 to slot #13 along a time axis or a frequency axis, backward from the end of a DownLink (DL) data burst region of a DL subframe. The backward direction is directed from slot #0 to slot #3, i.e. backward along the frequency axis, or from slot #0 to slot #12, i.e. backward along the time axis. For the sake of convenience, it is assumed herein that the fixed packets are allocated backward along the frequency axis in the DL burst region of the DL subframe.

For example, first fixed packets 110 are allocated to five slots, slot #0 to slot #4, second fixed packets 120 are allocated to three slots, slot #5 to slot #7, third fixed packets 130 are allocated to two slots, slot #8 and slot #9, and fourth fixed packets 140 are allocated to four slots, slot #10 to slot #13.

Also in an UpLink (UL) subframe, fixed packets are allocated to slot #0 to slot #13 along the time axis or the frequency axis, backward from the end of a UL data burst region. The backward direction is directed from slot #0 to slot #3, i.e. backward along the time axis, or from slot #0 to slot #12, i.e. backward along the frequency axis. For the sake of convenience, it is assumed herein that the fixed packets are allocated backward along the time axis in the UL burst region of the UL subframe.

For example, first fixed packets 110 are allocated to five slots, slot #0 to slot #4, second fixed packets 120 are allocated to three slots, slot #5 to slot #7, third fixed packets 130 are allocated to two slots, slot #8 and slot #9, and fourth fixed packets 140 are allocated to four slots, slot #10 to slot #13.

General packets are allocated forward from a part of the DL burst region of the DL subframe. The part of the DL burst region from which the general packets are allocated forward may be the beginning part of the DL burst region. The forward direction is directed from slot #31 to slot #28, i.e. forward along the frequency axis, or from slot #31 to slot #7, i.e. forward along the time axis. For the sake of convenience, it is assumed herein that the general packets are allocated forward along the frequency axis in the DL burst region of the DL subframe.

Also in the UL subframe, general packets are allocated forward from a part of the UL data burst region. The part of the UL burst region from which the general packets are allocated forward may be the beginning part of the UL burst region. The forward direction is directed from slot #139 to slot #136, i.e. forward along the time axis, or from slot #139 to slot #135, i.e. forward along the frequency axis. For the sake of convenience, it is assumed herein that the general packets are allocated forward along the time axis in the UL burst region of the UL subframe.

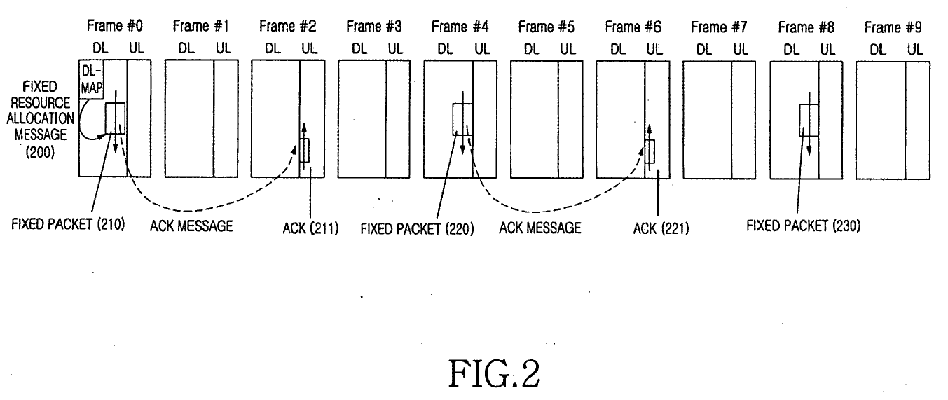

A description will be made of an operation for transmitting fixed packets in an HARQ communication system according to an exemplary embodiment of the present invention with reference to FIG. 2.

FIG. 2 illustrates an operation for transmitting fixed packets in the communication system according to an exemplary embodiment of the present invention.

Referring to FIG. 2, a BS transmits a fixed packet every four frames to an MS and the MS transmits to the BS an ACK/NACK message indicating whether the received fixed packet has errors. Herein, it is assumed that a frame including the fixed packet is two frames apart from a frame including the ACK/NACK message. Resources allocated to the ACK/NACK message, namely an ACKCH will be described later.

More specifically, the BS transmits a fixed resource allocation message 200 and a fixed packet 210 to the MS in a DL period of frame #0. The MS then checks for errors in the fixed packet 210. If the fixed packet 210 is without error, the MS transmits an ACK message 211 indicating to the BS, a successful reception of the fixed packet 210, on an ACKCH during a UL period of frame #2. Upon receipt of the ACK message 211, the BS determines that the MS has successfully received the fixed packet 210. During a DL period of frame #4, the BS transmits a new fixed packet 220 to the MS. Because the BS has already transmitted the fixed resource allocation message 200 to the MS in frame #0, the BS does not retransmit the fixed resource allocation message 200 to the MS in frame #4.

Upon receipt of the fixed packet 220, the MS checks for errors in the fixed packet 220. If the fixed packet 220 is successfully received, the MS transmits to the BS, an ACK message 221 indicating the successful reception of the fixed packet 220, on the ACKCH during a UL period of frame #6. Upon receipt of the ACK message 221, the BS transmits a new fixed packet 230 to the MS in frame #8, since the MS has successfully received the fixed packet 220.

Although the MS transmits the ACK messages for the fixed packets 210, 220 and 230 received from the BS, if any of the fixed packets 210, 220 and 230 has an error, the MS transmits a NACK message indicating a failed reception of the fixed packet to the BS.

A description will now be made of a method for allocating an ACKCH. ACKCH allocation is different depending on the type of a packet, i.e. a general packet or a fixed packet.

It is assumed that an ACKCH region is limited to a preset size. Regarding an ACKCH allocation method for general packets, Table 1 below will be referred to.

TABLE 1

| Fields | Description |
|---|---|
| xx_HARQ_ACKCH_Region_IE( ){ | |
| UIUC | Identification of the message |
| length | Message length |
| Symbol offset | Offset to the start of the region |
| | along symbol axis |
| Subchannel offset | Offset to the start of the region |
| | along subchannel axis |
| No. symbols | Number of symbols |
| No. subchannels | Number of subchannels |
| } | |

The BS transmits a resource allocation message having the configuration of Table 1 to each MS in order to indicate an ACKCH region for general packets in every frame. The resource allocation message is used for the BS to allocate an ACKCH to an MS supporting HARQ.

It is assumed that each ACKCH occupies a half of a slot in the ACKCH region and the BS transmits general packets to each MS in an i^{th} frame. Upon receipt of the general packets, the MSs transmit to the BS on ACKCHs ACK/NACK messages indicating whether the general packets have been received successfully. To transmit the ACK/NACK messages j frames (i.e. an ACK/NACK delay) after the i^{th} frame, the MSs allocate the ACK/NACK messages to the ACKCHs in the order of the general packets. For example, an MS receives an n^{th} general packet from the BS in the i^{th} frame and transmits to the BS, an ACK message indicating successful reception of the n^{th} general packet, on an ACKCH. The ACK message is transmitted to the BS on an n^{th} ACKCH among the ACKCHs included in an (1+j)^{th} frame.

Regarding an ACKCH allocation method for fixed packets, Table 2 below will be referred to.

TABLE 2

| Fields | Description |
|---|---|
| xx_IE( ){ | |
| Connection ID | Identification of service connection to |
| | be allocated in fixed allocation mode |
| Circuit ID | Identification used instead of |
| | Connection ID |
| Slot offset | Number of first slot allocated for fixed |
| | allocation mode packet |
| No. Slot | Number of slots allocated for fixed |
| | allocation mode packet |
| Period | Allocation period |
| DIUC,Repetition | Modulation and coding scheme |
| HARQ Enable | 0b0: HARQ is not used |
| | 0b1: HARQ is used |
| if (HARQ Enable==0b1){ | |
| UL ACKCH index | Index of ACK channel for DL HARQ |
| | packet |
| } | |
| } | |

The BS periodically transmits a fixed resource allocation message having the configuration of Table 2 to each MS in order to indicate an ACKCH region for fixed packets. The fixed resource allocation message is used for the BS to allocate an ACKCH to an MS supporting HARQ.

It is assumed that each ACKCH occupies a half of a slot in the ACKCH region and the BS transmits a fixed packet to an MS in an i^{th} frame. Upon receipt of the fixed packet, the MS transmits an ACK/NACK message to the BS, indicating whether the fixed packet has been successfully received, on an ACKCH corresponding to an ACK channel index (UL ACKCH index) set in the fixed resource allocation message. The ACK/NACK message is transmitted j frames (i.e. an ACK/NACK delay) after the i^{th} frame. For example, the MS receives an n^{th} fixed packet from the BS in the i^{th} frame and determines from an already-received fixed resource allocation message that it is to transmit an ACK/NACK message for the n^{th} fixed packet to the BS on an n^{th} ACKCH. Then the MS transmits the ACK/NACK message to the BS on the n^{th} ACKCH among the ACKCHs included in an (1+j)^{th} frame.

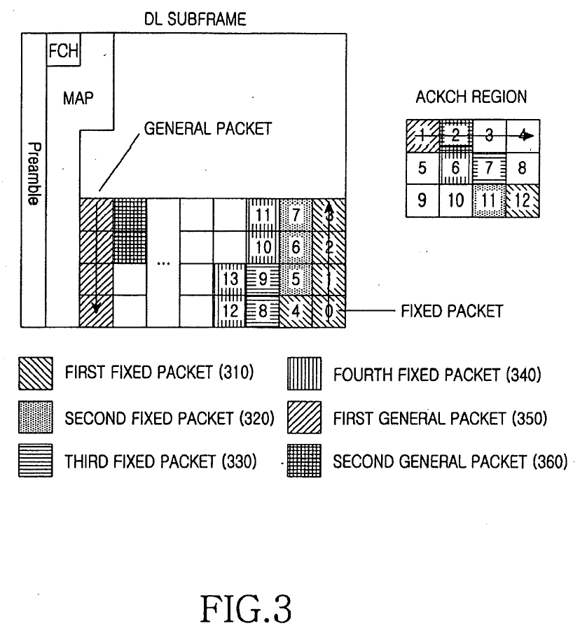

With reference to FIG. 3, an ACKCH allocation method in an HARQ communication system according to an exemplary embodiment of the present invention will be described below.

FIG. 3 illustrates an ACKCH allocation method in an HARQ communication system according to an exemplary embodiment of the present invention.

Referring to FIG. 3, first and second general packets 350 and 360 are allocated forward along the frequency axis in a part of a DL data burst region of a DL subframe. For instance, the first general packets 350 are allocated to four slots and the second general packets 360 are allocated to two slots. The part of the DL burst region from which the general packets are allocated forward may be the beginning part of the DL burst region.

First to fourth fixed packets 310 to 340 are allocated backward along the frequency axis, starting from the end of the DL data burst region of the DL subframe. For example, the first fixed packets 310 are allocated to five slots, slot #0 to slot #4, the second fixed packets 320 are allocated to three slots, slot #5, slot #6, and slot #7, the third fixed packets 330 are allocated to two slots, slot #8 and slot #9, and the fourth fixed packets 340 are allocated to four slots, slot #10 to slot #13.

ACKCHs used to indicate whether the general packets 350 and 360 have been received successfully are allocated forward in the transmission order of the general packets 350 and 360. The forward direction is forward along the time axis or along the frequency axis. Herein, the forward direction is forward along the time axis. That is, ACK/NACK messages for the first general packets 350 are allocated to ACKCH #1, and ACK/NACK messages for the second general packets 360 are allocated to ACKCH #2.

ACKCHs used to indicate whether the fixed packets 310 to 340 have been successfully received are allocated according to information included in a fixed resource allocation message. For instance, ACK/NACK messages for the first fixed packets 310 are allocated to ACKCH #12, and ACK/NACK messages for the second fixed packets 320 are allocated to ACKCH #11. ACK/NACK messages for the third fixed packets 330 are allocated to ACKCH #7, and ACK/NACK messages for the fourth fixed packets 340 are allocated to ACKCH #6.

As described above, the ACKCHs for the general packets 350 and 360 are successively allocated according to the transmission order of the general packets 350 and 360, whereas the ACKCHs for the fixed packets 310 to 340 are successively or non-successively allocated based on ACKCH region information included in the fixed resource allocation message. Since ACKCHs #12, 11, 7 and 6 are allocated in a fixed manner to the fixed packets 310 to 340, respectively, the MS transmits the ACK/NACK messages on the fixed ACKCHs to the BS.

If the BS transmits eight general packets, the MS should allocate eight ACKCHs forward along the time axis to notify whether the eight general packets have been successfully received. However, since ACKCHs #6 and #7 are allocated to fixed packets, up to five ACK/NACK messages are available to the eight general packets. In other words, when the BS transmits a sixth general packet to the MS, an ACKCH is likely to serve both the general packet and a fixed packet because ACKCH #6 corresponding to the sixth general packet has already been allocated to the fixed packet.

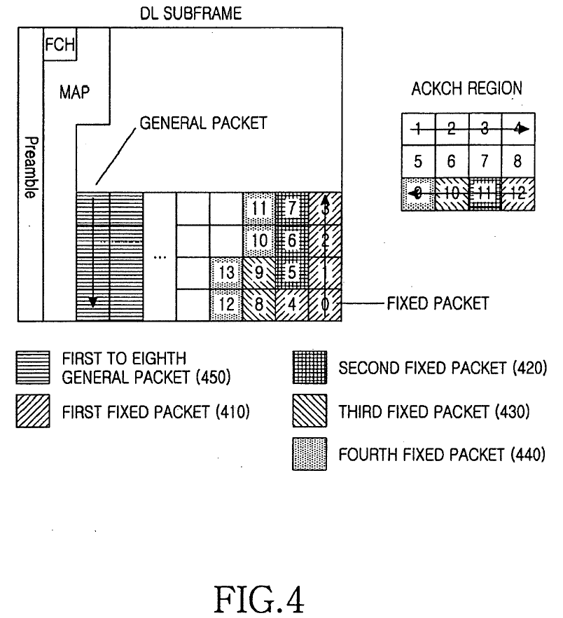

With reference to FIG. 4, an ACKCH allocation method in the HARQ communication system according to an exemplary embodiment of the present invention will be described.

FIG. 4 illustrates an ACKCH allocation method in the HARQ communication system according to an exemplary embodiment of the present invention.

Referring to FIG. 4, first to eighth general packets 450 are allocated to a part of a DL data burst region. The first to eighth general packets 450 are allocated, each to one slot, for example. First to fourth fixed packets 410 to 440 are allocated backward along the frequency axis, starting from the end of a DL burst region of a DL subframe.

For example, the first fixed packets 410 are allocated to five slots, slot #0 to slot #4, the second fixed packets 420 are allocated to three slots, slot #5, slot #6, and slot #7, the third fixed packets 430 are allocated to two slots, slot #8 and slot #9, and the fourth fixed packets 440 are allocated to four slots, slot #10 to slot #13.

To indicate whether the eight general packets 450 have been successfully received, ACKCHs #1 to #8 are successfully allocated forward along the time axis in the transmission order of the general packets 450. To indicate whether the fixed packets 310 to 340 have been successfully received, successive ACKCHs #12, 11, 10 and 9 are allocated backward along the time axis, starting from the end of the ACKCH region. This ACKCH allocation scheme considerably reduces the likelihood of redundantly allocating an ACKCH to both a general packet and a fixed packet.

If the transmission of the first fixed packets 410 is canceled, ACKCH #12 set for the first fixed packets 410 is unused.

If the BS transmits the eight general packets 450, the MS transmits to the BS, ACK/NACK messages for the eight general packets, on ACKCHs #1 to #8. When the BS transmits to the MS a ninth general packet, the MS is to transmit on ACKCH #9 an ACK/NACK message for the ninth general packet, which does not happen because ACKCH #9 is fixed for the fourth fixed packets 440. Although ACKCH #12 is unused due to cancellation of the transmission of the first fixed packets 410, the ACK/NACK message for the ninth general packet cannot be transmitted due to a shortage of ACKCHs because ACKCH #12 is fixed for the first fixed packets 410.

The fixed resource allocation message is valid until it is changed or deleted by another fixed resource allocation message. In other words, allocated ACKCHs are neither changed nor released until the BS transmits a new fixed resource allocation message. Even though an unused (HOLE) ACKCH results from cancellation of transmission of a fixed packet, an ACK/NACK message for a general packet cannot be transmitted on the HOLE ACKCH. Accordingly, a method for using the HOLE ACKCH to indicate whether the general packet has been successfully received is proposed according to an exemplary embodiment of the present invention.

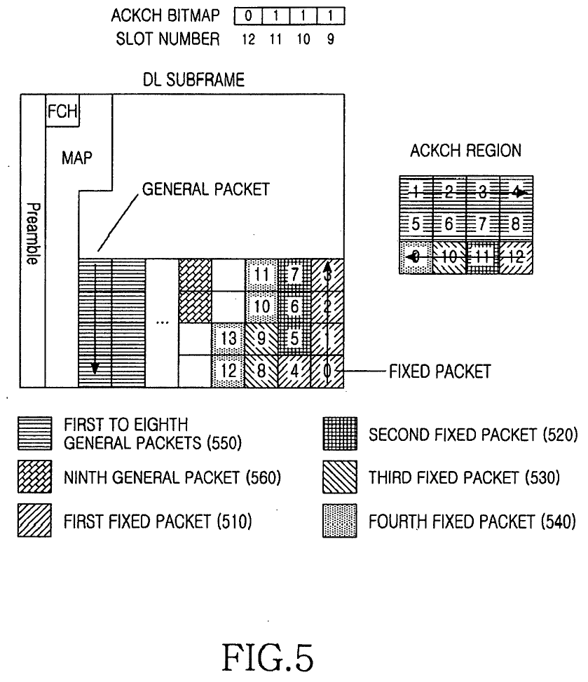

With reference to FIG. 5, an ACKCH allocation method in the HARQ communication system according to an exemplary embodiment of the present invention will be described below.

FIG. 5 illustrates an ACKCH allocation method in the HARQ communication system according to an exemplary embodiment of the present invention.

Referring to FIG. 5, ACKCHs for fixed packets are successfully allocated backward along the time axis, starting from the end of the ACKCH region. The BS transmits an ACKCH bitmap to the MS to indicate whether transmissions of fixed packets from the BS are canceled. That is, whether the ACKCHs allocated to indicate whether the fixed packets have been successfully received are used.

The ACKCH bitmap indicates whether the ACKCHs for the fixed packets are used or not by using as many bits as the number of the ACKCHs for the fixed packets, counted backward along the time axis starting from the end of a MAP region.

For example, if an n^{th} bit of the ACKCH bitmap is set to 1, an n^{th} ACKCH counted backward along the time axis is used among the ACKCHs for the fixed packets. If an m^{th} bit of the ACKCH bitmap is set to 0, an m^{th} ACKCH counted backward along the time axis is not used among the ACKCHs for the fixed packets.

Upon receipt of the ACKCH bitmap, the MS detects HOLE ACKCHs (bits set to 0) among the ACKCHs for the fixed packets and determines that ACK/NACK messages for general packets can be transmitted on the HOLE ACKCHs.

The BS can optionally use the ACKCH bitmap. If the BS determines that an unused ACKCH is to be used to carry an ACK/NACK message for a general packet, the BS transmits the ACKCH bitmap to the MS. The optional use of the ACKCH bitmap leads to a decrease in the overhead of transmitting the ACKCH bitmap.

An exemplary ACKCH bitmap transmitted in a resource allocation message will be described referring to Table 3 below.

TABLE 3

| Fields | Description |
|---|---|
| UL_ACKCH_Bitmap_IE( ){ | |
| type | Type of IE |
| bitmap length | Length of bitmap |
| (Compressed) ACKCH Bitmap | |
| } | |

Referring to Table 3, “type” denotes that the ACKCH bitmap is a resource allocation message. ACKCH Bitmap can be compressed by a preset compression algorithm, which is beyond the scope of the exemplary embodiment of the present invention and thus will not be described in detail herein. “Bitmap length” denotes the length of the ACKCH bitmap.

To be more specific, first to eighth general packets 550 are successively allocated forward along the frequency axis in a part of a DL data burst region of a DL subframe. For example, the first to eighth general packets 550 are allocated, each to one slot. The part of the DL burst region from which the general packets are allocated forward may be the beginning part of the DL burst region.

First to fourth fixed packets 510 to 540 are allocated backward along the frequency axis, starting from the end of the DL burst region of the DL subframe.

For example, the first fixed packets 510 are allocated to five slots, slot #0 to slot #4, the second fixed packets 520 are allocated to three slots, slot #5, slot #6, and slot #7, the third fixed packets 530 are allocated to two slots, slot #8 and slot #9, and the fourth fixed packets 540 are allocated to four slots, slot #10 to slot #13.

ACKCHs #1 to #8 are allocated successively forward along the time axis in the transmission order of the general packets 550. ACKCHs #12, 11, 10 and 9 are allocated successively backward along the time axis, stating form the end of the ACKCH region.

If the transmission of the first fixed packets 510 is canceled, ACKCH #12 set for the first fixed packets 510 becomes a HOLE ACKCH.

When the BS determines to transmit one more packet, i.e. a ninth general packet 560, it transmits an ACKCH bitmap message to the MS to indicate that ACKCH #12 is a HOLE ACKCH.

The BS then sequentially transmits the first to ninth general packets. Upon receipt of the nine general packets, the MS transmits ACK/NACK messages for the first to eighth general packets on AKCH #1 to ACKCH #8 to the BS. With the knowledge that ACKCH #12 is in HOLE state, the MS transmits an ACK/NACK message for the ninth general packet 560 on ACKCH #12 to the BS.

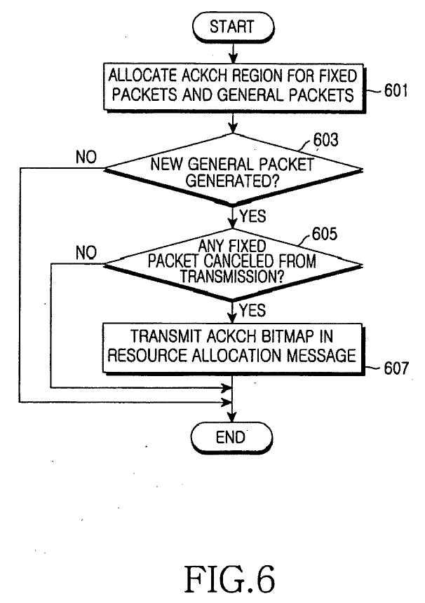

With reference to FIG. 6, an operation of a BS for allocating ACKCHs efficiently when general packets and fixed packets exist in the communication system according to an exemplary embodiment of the present invention will be described below.

FIG. 6 is a flowchart illustrating an operation of a BS in the communication system according to an exemplary embodiment of the present invention.

Referring to FIG. 6, the BS allocates ACKCHs to first to fourth fixed packets and first to eighth general packets in step 601. It is assumed herein that the ACKCH region includes 12 ACKCHs and ACKCHs are allocated to ACK/NACK messages for the fixed packets, backward from the end of the ACKCH region along the time axis. That is, ACKCH #12 is allocated to an ACK/NACK message for the first fixed packet, and ACKCH #11 is allocated to an ACK/NACK message for the second fixed packet. ACKCH #10 and ACKCH #9 are allocated to ACK/NACK messages for the third and fourth fixed packets, respectively.

It is assumed that successive ACKCHs #1 to #8 are allocated to ACK/NACK messages for the first to eighth general packets.

In step 603, the BS monitors generation of a new ninth general packet. Because ACKCHs #9 to #12 are allocated to the fixed packets and ACKCHs #1 to #8 are allocated to the general packets, there is no ACKCH available to an ACK/NACK message for the ninth general packet. Upon generation of the ninth general packet, the BS proceeds to step 605, and otherwise, it ends the procedure.

In step 605, the BS determine whether there is any fixed packet whose transmission is cancelled among the first to fourth fixed packets. If one fixed packet, for example, the first fixed packet is canceled from transmission, the BS goes to step 607. In the absence of a fixed packet whose transmission is canceled, the BS ends the procedure.

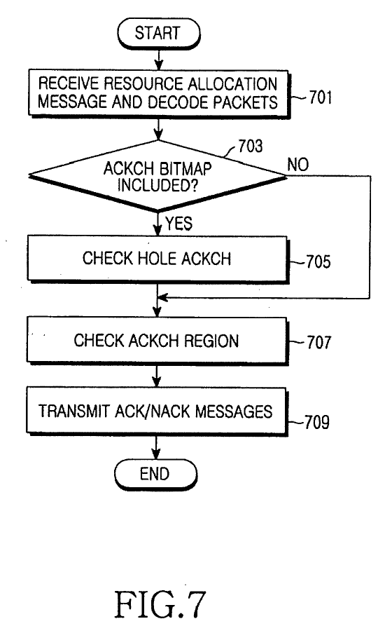

The BS transmits an ACKCH bitmap indicating that ACKCH #12 allocated to the ACK/NACK message for the first fixed packet is in HOLE state to the MS in step 607. The ACKCH bitmap can be included in a resource allocation message. With reference to FIG. 7, a description will be made of an operation of an MS for acquiring an ACKCH region in the communication system according to an exemplary embodiment of the present invention.

FIG. 7 is a flowchart illustrating an operation of an MS for acquiring an ACKCH region in the communication system according to an exemplary embodiment of the present invention.

Referring to FIG. 7, the MS receives a resource allocation message from a BS in step 701. The MS receives first to ninth general packets and first, second and third fixed packets from the BS and decodes the resource allocation message and the general packets and the fixed packets.

In step 703, the MS determines whether the resource allocation message includes an ACKCH bitmap. In the presence of the ACKCH bitmap, the MS goes to step 705 and in the absence of the ACKCH bitmap, the MS goes to step 707.

The MS decodes the ACKCH bitmap and detects a HOLE ACKCH, for example, a HOLE ACKCH #12 in step 705.

In step 707, the MS checks an ACKCH region. For example, ACKCHs #9, 10 and 11 are allocated to ACK/NACK messages for the fixed packets and ACKCHs #1 to #8 are allocated to ACK/NACK messages for the first to eighth general packets in the ACKCH region. The MS is aware that ACKCH #12 is in HOLE state from the ACKCH bitmap.

In step 709, the MS transmits ACK/NACK messages for the first to eighth general packets to the BS on ACKCHs #1 to #8 in the reception order of the general packets. In addition, the MS transmits an ACK/NACK message for the ninth general packet on ACKCH #12 in HOLE state to the BS.

In addition, the MS transmits ACK/NACK messages for the first, second and third fixed packets on ACKCHs #11, 10 and 9 to the BS.

As is apparent from the above description of exemplary embodiments of the present invention, when a BS transmits general packets and fixed packets to an MS, the MS uses an ACKCH for a canceled fixed packet as one for a general packet. Therefore, ACKCHs for the general packets and the fixed packets can be efficiently utilized.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method for allocating feedback resources for a Base Station (BS) in a communication system, the method comprising:
allocating a first feedback resource area for ACKnowledgment/Negative ACKnowledgment (ACK/NACK) messages of general packets and a second feedback resource area for ACK/NACK messages of fixed packets;
transmitting the general packets and the fixed packets to at least one Mobile Station (MS);
receiving ACK/NACK messages through the first and second feedback resource areas; and
transmitting to the at least one MS, when at least one of the fixed packets is canceled from transmission after the transmission of the general packets and the fixed packets, a bitmap message indicating use or non-use of the second feedback resource area for each packet, to enable a feedback resource area allocated for the canceled fixed packet to be allocated to an ACK/NACK message for an additionally generated general packet.

2. The method of claim 1, wherein the general packets are allocated to successive areas along a forward direction from a first area in a data burst region of a frame, and the fixed packets are allocated to successive areas along a backward direction from a second area in the data burst region of the frame.

3. The method of claim 1, wherein the ACK/NACK messages for the general packets are allocated to successive channels along a forward direction from a first channel in an ACK/NACK Channel (ACKCH) region of a frame, and the ACK/NACK messages for the fixed packets are allocated to successive channels along a backward direction from a last channel in the ACKCH region of the frame.

4. The method of claim 1, further comprising receiving the ACK/NACK message for the additionally generated general packet in the feedback resource area allocated for the canceled fixed packet, when feedback resources cannot be allocated for the ACK/NACK message for the additionally generated general packet.

5. The method of claim 1, wherein the bitmap message includes at least one of information about a type indicating that the bitmap message is a resource allocation message, information about the length of the bitmap message, and information indicating whether the bitmap message is compressed.

6. The method of claim 1, wherein the bitmap message is included in a resource allocation message.

7. A method for allocating feedback resources for a Mobile Station (MS) in a communication system, the method comprising:
acquiring a first feedback resource area allocated for ACKnowledgment/Negative ACKnowledgment (ACK/NACK) messages of general packets and a second feedback resource area allocated for ACK/NACK messages of fixed packets;
receiving the general packets and the fixed packets from a Base Station (BS);
transmitting the ACK/NACK messages through the first and second feedback resource areas to the BS; and
receiving from the BS, when at least one of the fixed packets is canceled from transmission after transmission of the general packets and the fixed packets from the BS, a bitmap message indicating use or non-use of the second feedback resource area for each packet, to enable a feedback resource area allocated for the canceled fixed packet to be allocated to an ACK/NACK message for an additionally generated general packet.

8. The method of claim 7, wherein the general packets are allocated to successive areas along a forward direction from a first area in a data burst region of a frame, and the fixed packets are allocated to successive areas along a backward direction from a second area in the data burst region of the frame.

9. The method of claim 7, wherein the ACK/NACK messages for the general packets are allocated to successive channels along a forward direction from a first channel in an ACK/NACK Channel (ACKCH) region of a frame, and the ACK/NACK messages for the fixed packets are allocated to successive channels along a backward direction from a last channel in the ACKCH region of the frame.

10. The method of claim 7, further comprising transmitting the ACK/NACK message for the additionally generated general packet in the feedback resource area allocated for the canceled fixed packet, when feedback resources cannot be acquired for the ACK/NACK message for the additionally generated general packet.

11. The method of claim 7, wherein the bitmap message includes at least one of information about a type indicating that the bitmap message is a resource allocation message, information about the length of the bitmap message, and information indicating whether the bitmap message is compressed.

12. The method of claim 7, wherein the bitmap message is included in a resource allocation message received from the BS.

13. A system for allocating feedback resources in a communication system, the system comprising:
at least one Mobile Station (MS); and
a Base Station (BS) for allocating a first feedback resource area for ACKnowledgment/Negative ACKnowledgment (ACK/NACK) messages of general packets and a second feedback resource area for ACK/NACK messages of fixed packets, for transmitting the general packets and the fixed packets to the at least one MS, for receiving ACK/NACK messages through the first and second feedback resource areas, and for transmitting, when at least one of the fixed packets is canceled from transmission after the transmission of the general packets and the fixed packets, a bitmap message indicating use or non-use of the second feedback resource area for each packet to the at least one MS, to enable a feedback resource area allocated for the canceled fixed packet to be allocated to an ACK/NACK message for an additionally generated general packet.

14. The system of claim 13, wherein the general packets are allocated to successive areas along a forward direction from a first area in a data burst region of a frame, and the fixed packets are allocated to successive areas along a backward direction from a second area in the data burst region of the frame.

15. The system of claim 13, wherein the ACK/NACK messages for the general packets are allocated to successive channels along a forward direction from a first channel in an ACK/NACK Channel (ACKCH) region of a frame, and the ACK/NACK messages for the fixed packets are allocated to successive channels along a backward direction from a last channel in the ACKCH region of the frame.

16. The system of claim 13, wherein the BS receives the ACK/NACK message for the additionally generated general packet in the feedback resource area allocated for the canceled fixed packet, when feedback resources cannot be allocated for the ACK/NACK message for the additionally generated general packet.

17. The system of claim 13, wherein the bitmap message includes at least one of information about a type indicating that the bitmap message is a resource allocation message, information about the length of the bitmap message, and information indicating whether the bitmap message is compressed.

18. The system of claim 13, wherein the bitmap message is included in a resource allocation message.

19. A system for allocating feedback resources in a communication system, the system comprising:
a Base Station (BS); and
a Mobile Station (MS) for acquiring a first feedback resource area allocated for ACKnowledgment/Negative ACKnowledgment (ACK/NACK) messages of general packets and a second feedback resource area allocated for ACK/NACK messages of fixed packets, for receiving the general packets and the fixed packets from the BS, for transmitting the ACK/NACK messages through the first and second feedback resource areas to the BS, and for receiving from the BS, when at least one of the fixed packets is canceled from transmission after transmission of the general packets and the fixed packets from the BS, a bitmap message indicating use or non-use of the second feedback resource area for each packet, to enable a feedback resource area allocated for the canceled fixed packet to be allocated to an ACK/NACK message for an additionally generated general packet.

20. The system of claim 19, wherein the general packets are allocated to successive areas along a forward direction from a first area in a data burst region of a frame, and the fixed packets are allocated to successive areas along a backward direction from a second area in the data burst region of the frame.

21. The system of claim 19, wherein the ACK/NACK messages for the general packets are allocated to successive channels along a forward direction from a first channel in an ACK/NACK Channel (ACKCH) region of a frame, and the ACK/NACK messages for the fixed packets are allocated to successive channels along a backward direction from a last channel in the ACKCH region of the frame.

22. The system of claim 19, wherein the MS transmits the ACK/NACK message for the additionally generated general packet in the feedback resource area allocated for the canceled fixed packet, when feedback resources cannot be acquired for the ACK/NACK message for the additionally generated general packet.

23. The system of claim 19, wherein the bitmap message includes at least one of information about a type indicating that the bitmap message is a resource allocation message, information about the length of the bitmap message, and information indicating whether the bitmap message is compressed.

24. The system of claim 19, wherein the bitmap message is included in a resource allocation message.
